(19) United States
(12) Patent Application Publication
(10) Pub. No.: US 2025/0099320 A1
(43) Pub. Date: Mar. 27, 2025

(54) Massager

(71) Applicants: Dongguan Luoge Adult Product Co., Ltd, Dongguan (CN); Shenzhen Envision Technology Innovation Co., Ltd., Shenzhen (CN)

(72) Inventor: Jianhong CHEN, Dongguan (CN)

(21) Appl. No.: 18/892,321

(22) Filed: Sep. 20, 2024

(30) Foreign Application Priority Data
Sep. 22, 2023 (CN) 202322598903.1

(51) Int. Cl. A61H 15/00

(52) U.S. Cl. CPC A61H 15/0085; A61H 2201/1215; A61H 2201/16; A61H 2205/00

(57) ABSTRACT

A massager includes a casing having an elongated slot on one lateral side, a motor housed in the casing, a leadscrew housed in the casing and extending along a long axis and coupled with an output end of the motor, a slide rail seat housed in the casing and threadedly coupled to the leadscrew, a massage head disposed outside the casing and connected to the slide rail seat via a connection seat extending through the elongated slot from inside the casing to outside of the casing. When in operation, the motor causes the leadscrew to rotate about the long axis to thereby drive the massage head to reciprocate linearly along the long axis relative to the casing.

### TECHNICAL FIELD

This invention relates to the field of health care massage products, specifically to a penis massager.

### BACKGROUND

As society rapidly develops, people are encountering increased pressures in both their personal and professional lives, leading to a growing demand for higher-quality living standards. Massage therapy has become a popular way to relax and relieve fatigue, prompting the creation of various types of massage devices. In recent years, as China's domestic manufacturing capabilities have improved, the global market has seen a strong demand for Chinese-made massage equipment. This has positioned China as a leading center for the production of massage equipment worldwide.

The existing penis massager design usually has long overall length that makes the device inconvenient to carry and store. Additionally, the stroke length of the massager sleeve often has limited range, which can cause arm fatigue during use. Prolonged use can easily result in arm soreness, leading to a subpar user experience.

### SUMMARY OF THE INVENTION

According to embodiments of the present invention, a massager is provided, which includes: a casing comprising an elongated slot on one lateral side; a motor housed in the casing; a leadscrew housed in the casing and extending along a long axis, the leadscrew having a first end coupled with an output end of the motor via a coupling; a slide rail seat housed in the casing and threadedly coupled to the leadscrew; a massage head disposed outside the casing and connected to the slide rail seat via a connection seat extending through the elongated slot from inside the casing to outside of the casing, wherein in operation, the motor causes the leadscrew to rotate about the long axis to thereby drive the massage head to reciprocate linearly along the long axis relative to the casing.

The massager can further include a battery disposed inside the casing which powers the motor. The massager can further include a PCBA board, wherein the battery, the motor and massage head are all electrically connected to the PCBA board.

The massager can further include at least one guide rail on which the slide rail seat is slidably sleeved. The at least one guide rail can be fixed on a guide rail fixing base connected to the casing. The at least one guide rail can include two guide rails disposed on opposing sides of the leadscrew. The massager can further include a guide rail fixing base and a motor fixing base, wherein one end of the two guide rails is fixed to the guide rail fixing base, the other end of the two guide rails is fixed to one side of the motor fixing base, the motor is fixed to the other side of the motor fixing base, the leadscrew is disposed in the middle of the two guide rails.

The massager can further include a copper pin having one end extending out of an end surface of the connection seat proximal to the massage head, and another end electrically connecting to the PCBA board. The casing can include a silicone button having one end in contact with the PCBA board. The casing can include an upper shell and a lower shell that are engaged with each other, where the elongated slot is located at a junction between the upper shell and the lower shell.

### BRIEF DESCRIPTION OF THE DRAWINGS

FIG. 1 is a perspective view of a massager of an embodiment of the present invention.

FIG. 2 is another perspective view thereof.

FIG. 3 is an exploded view thereof.

FIG. 4 is another exploded view thereof.

### REFERENCE NUMBERS IN THE DRAWINGS

1-Outer casing
11-Upper shell
12-Lower shell
13-Slot
14-Charging port
15-Charging PCB board
16-Silicone button
2-PCBA board
3-Battery
41-Leadscrew
42-Guide rail fixing base
43-Motor fixing base
44-Coupling
45-Guide rail
5-Slide rail seat
6-Connection seat
61-Copper pin
7-Brushless motor
8-Massage head
9-Assistive strap.

### DETAILED DESCRIPTION

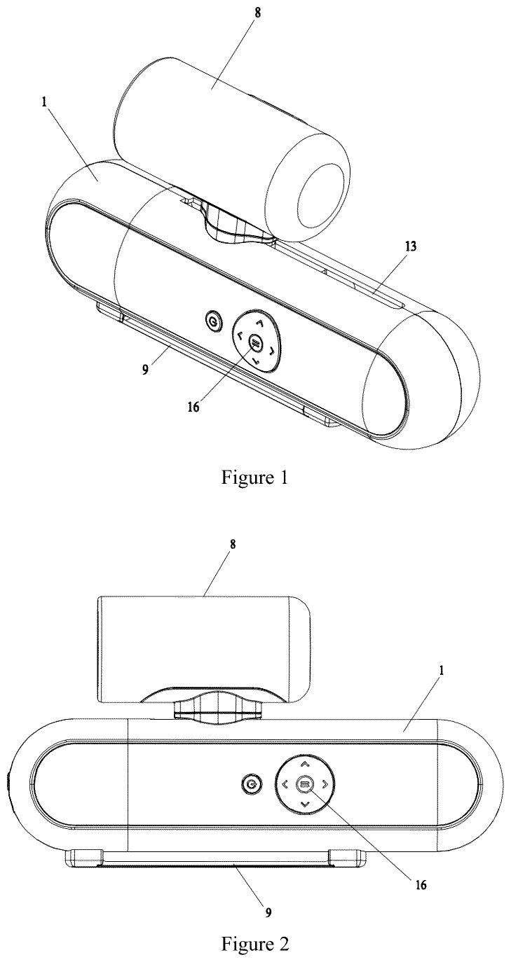

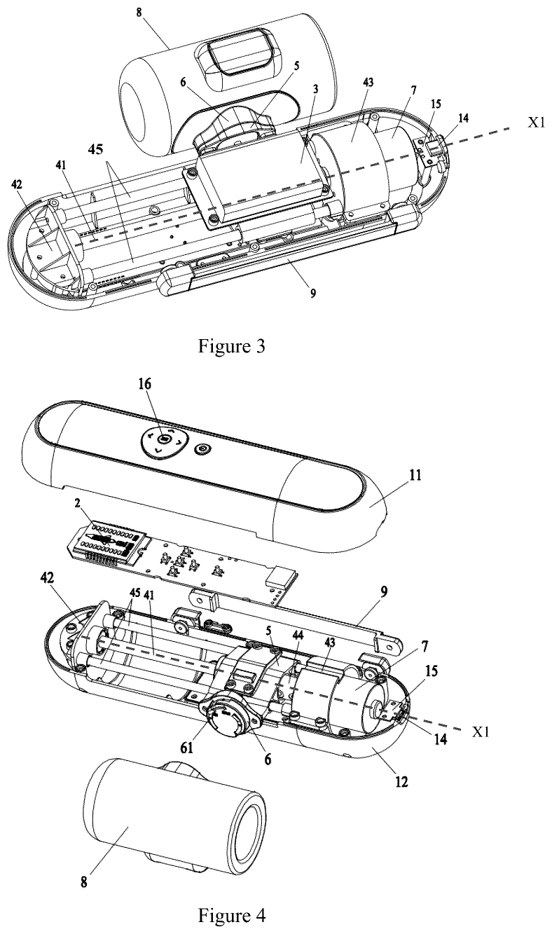

To assist those skilled in the art in understanding the disclosed subject matter, further description is provided below with reference to FIGS. 1-4. The description of the embodiments does not limit the invention.

As shown in FIGS. 1-4, a massager includes a casing (1), a printed circuit board assembly (PCBA) board (2), a battery (3), a sliding assembly, a slide rail seat (5), a connection seat 6, a brushless motor (7), and a massage head (8). The sliding assembly is fixed inside the casing (1). The slide rail seat (5) is sleeved on the sliding assembly. One end of the connection seat (6) is fixed to the slide rail seat (5) while the other end extends out of the casing (1) and connects to the massage head (8). The brushless motor (7) is fixed at one end of the sliding assembly and can drive the slide rail seat (5) to reciprocate along the sliding assembly.

The battery (3) is fixed on one side of the sliding assembly, and the PCBA board (2) is fixed on the other side, with the battery (3), brushless motor (7), and massage head (8) all electrically connected to the PCBA board (2).

The sliding assembly includes a leadscrew (41) extending along a long axis X1, a guide rail fixing base (42), a motor fixing base (43), a coupling (44), and a set of guide rails (45). One end of the guide rails (45) is fixed to the guide rail fixing base (42), and the other end is fixed to one side of the motor fixing base (43). The brushless motor (7) is fixed on the other side of the motor fixing base (43), securely attaching the guide rails (45) and brushless motor (7) inside the casing (1), thereby enhancing the structural stability of the massager. The leadscrew (41) is positioned in the middle of the two guide rails (45) which flank on the opposing sides of the leadscrew, with one end of the leadscrew (41) connected to at an output end of the brushless motor (7) via the shaft coupling (44), and the other end of the leadscrew (41) passes through the slide rail seat (5) and is threadedly connected to it. The slide rail seat (5) is slidably sleeved on the guide rails (45).

The structure of the massager as shown in this embodiment is simple and easy to use. By separating the massage head (8) and the drive mechanism, the brushless motor (7) when in operation drives the leadscrew (41) to rotate about the long axis X1, which in turn drives the slide rail seat (5) to reciprocate linearly on the guide rails (45). The massage head (8) moves together with the connection seat (6), achieving a long-stroke movement of the massage head (8) relative to the casing (1). The massage head (8) can include a lumen lined with soft material to accommodate a body part, for example, a penis. The compact structure of the massager allow it to be easily carried and stored.

As shown in the figures, one lateral side of the casing (1) includes an elongated slot (13). One end of the connection seat (6) extends into the slot (13) and connects to the slide rail seat (5), allowing the connection seat (6) to slide along the slot (13). The massager casing (1) include an upper shell (11) and a lower shell (12) that snap together, facilitating easy assembly and disassembly. The slot (13) at the junction of the upper shell (11) and lower shell (12) allows the slide rail seat (5) to drive the connected seat (6) to slide along the slot (13) as it moves along the guide rails (45), enabling the massage head (8) to move back and forth along the long axis X1. This allows increased movement range of the massage head (8).

The wall of the upper shell (11) is equipped with a silicone button (16) for adjusting the massage mode (e.g., changing the rotation direction and number of turns of the brushless motor (7) on each direction). One end of the silicone button (16) is in contact with the PCBA board (2). Inside the connection seat (6), there is a copper pin (61), with one end extending out of the connection seat (6) near an end surface proximal to the massage head (8). The other end of the copper pin (61) is electrically connected to the PCBA board (2).

The massage head (8) is detachably connected to the connection seat (6) via a snap connection, allowing the massage head (8) to be replaced according to actual needs. This also facilitates the removal and regular cleaning of the massage head (8). The copper pin (61) inside the connection seat (6) contacts a copper sheet on the massage head (8), enabling the PCBA board (2) to operate a vibration motor (not shown) inside the massage head (8), achieving a better massage effect.

A lateral side of the casing (1) has an assistive strap (9) for the user to grip during use, reducing the risk of dropping and damaging the massager due to arm fatigue. An end of the casing (1) includes a charging port (14) connected to a charging PCB board (15), which is electrically connected to the PCBA board (2).

The above embodiments represent the certain implementation of this invention. However, the present invention can be implemented in other ways as well. Any obvious modifications herein are covered within the protection scope of this invention.

1. A massager comprising:
a casing comprising an elongated slot on one lateral side;
a motor housed in the casing;
a leadscrew housed in the casing and extending along a long axis, the leadscrew having a first end coupled with an output end of the motor via a coupling;
a slide rail seat housed in the casing and threadedly coupled to the leadscrew;
a massage head disposed outside the casing and connected to the slide rail seat via a connection seat extending through the elongated slot from inside the casing to outside of the casing,
wherein in operation, the motor causes the leadscrew to rotate about the long axis to thereby drive the massage head to reciprocate linearly along the long axis relative to the casing.

2. The massager of claim 1, further comprising:
a battery disposed inside the casing which powers the motor.

3. The massager of claim 2, further comprising:
a PCBA board, wherein the battery, the motor and massage head are all electrically connected to the PCBA board.

4. The massager of claim 3, further comprising:
at least one guide rail extending along the long axis on which the slide rail seat is slidably sleeved, the at least one guide rail is fixed on a guide rail fixing base connected to the casing.

5. The massager of claim 4, wherein the at least one guide rail comprises two guide rails, the massager further comprising:
a guide rail fixing base and a motor fixing base, wherein one end of the two guide rails is fixed to the guide rail fixing base, the other end of the two guide rails is fixed to one side of the motor fixing base, the motor is fixed to the other side of the motor fixing base, the leadscrew is disposed in the middle of the two guide rails.

6. The massager of claim 5, further comprising:
a copper pin having one end extending out of an end surface of the connection seat proximal to the massage head, and another end electrically connecting to the PCBA board.

7. The massager of claim 1, wherein the casing comprises an upper shell and a lower shell that are engaged with each other, and the elongated slot is located at a junction between the upper shell and the lower shell.

8. The massager of claim 3, further comprising:
a silicone button disposed on the casing, one end of the silicone button is in contact with the PCBA board.
